(19) United States
(12) Patent Application Publication
(10) Pub. No.: US 2005/0216829 A1
(43) Pub. Date: Sep. 29, 2005

(54) Wireless content validation

(76) Inventors: Boris Kalinichenko, Jamaica Plain, MA (US); Yevgeny Safontchik, N Chelmsford, MA (US)

Correspondence Address: FISH & RICHARDSON PC, P.O. BOX 1022, MINNEAPOLIS, MN, 55440-1022, US

(21) Appl. No.: 10/809,625

(22) Filed: Mar. 25, 2004

(51) Int. Cl. G06F 17/00

(52) U.S. Cl. 715/513; 715/501.1; 707/3

(57) ABSTRACT

There are methods and apparatus, including computer program products, for validating wireless content on a system. A first web crawling process is performed to retrieve a first set of content files by identifying a link in a first content file and following the link to a second content file. The content at the second content file is based on the first content file. The retrieved first set of files is analyzed for errors by emulating a first category of wireless devices. A log file including error information and a navigation history is generated. The navigation history includes paths of links traversed during the first web crawling process. A second web crawling process is performed by traversing the path of links defined by the navigation history to retrieve a second set of content files. The second set of files is analyzed for errors by emulating a second category of wireless devices.

### BACKGROUND

This description relates to wireless content validation. Wireless devices work on different wireless networks, support different operating systems and languages, and have differences in device attributes, such as device display characteristics, device input methods, character encoding methods, to name a few. The Wireless Application Protocol (WAP) has been developed as an open, global specification that empowers mobile users with wireless devices to easily access remote content in a manner similar to computer users accessing Web pages. WAP bridges the gap between the mobile world and the Internet, as well as corporate intranets, and offers the ability to deliver an unlimited range of mobile value-added services to subscribers—independent of their network, bearer, and terminal. Mobile subscribers can access the same wealth of information from a pocket-sized device as they can from the desktop.

WAP is a global standard and is not controlled by any single company. Ericsson, Nokia, Motorola, and Openwave (then called “Unwired Planet”) founded the WAP Forum in the summer of 1997 with the initial purpose of defining an industry-wide specification for developing applications over wireless communications networks. The WAP specifications define a set of protocols in application, session, transaction, security, and transport layers, which enable operators, manufacturers, and applications providers to meet the challenges in advanced wireless service differentiation and fast/flexible service creation. There are now over one hundred members representing terminal and infrastructure manufacturers, operators, carriers, service providers, software houses, content providers, and companies developing services and applications for mobile devices.

The lightweight WAP protocol stack is designed to minimize the required bandwidth and maximize the number of wireless network types that can deliver WAP content. These network types include global system for mobile communications (GSM) 900, 1,800, and 1,900 MHz; interim standard (IS)—136; digital European cordless communication (DECT); time-division multiple access (TDMA), personal communications service (PCS), code division multiple access (CDMA), and other carriers. All network technologies and bearers will also be supported, including short message service (SMS), circuit-switched cellular data (CSD), cellular digital packet data (CDPD), and general packet radio service (GPRS).

Applications for WAP-enabled wireless devices are generally written in wireless markup language (WML), which is a subset, of extensible markup language (XML). Other markup languages, such as xHTML may also be used. Using the same model as the Internet, WAP enables content and application developers to grasp the tag-based WML, which enables services to be written and deployed within an operator's network quickly and easily. WAP also provides convenient content presentation on mobile devices having different physical limitations, such as screen size, keyboard layout etc. As WAP is a global and interoperable open standard supported by many wireless carriers, content providers have immediate access to a wealth of potential customers who will seek such applications to enhance the service offerings given to their own existing and potential subscriber base.

### SUMMARY

The techniques described herein provide methods and apparatus, including computer program products, for validating wireless content.

In general in one aspect, there is a method for validating wireless content. The method includes performing a first web crawling process to retrieve a first set of content files from a web site, analyzing the first set of content files for errors by emulating a first category of wireless devices, and generating a log file including a navigation history and error information, wherein the navigation history includes one or more paths of links traversed during the first web crawling process. The first web crawling process includes identifying a link in a first content file of the first set, and following the link to a second content file of the first set, the second content file including content based on the first content file.

In other examples, the method can include one or more of the following features. The method can include using information about characteristics of the first category of wireless devices to analyze content in the retrieved first set for errors that may occur in the use of the retrieved content at a wireless, device in the first category. The content can be analyzed by identifying a first list of language elements that are supported by the first category of wireless devices, and performing a syntax check of the first set of content files using the first set of language elements. The first set of language elements may define a markup language format. Alternatively, the content can be analyzed by performing a semantic check of the first set of content files based on the characteristics of the first category of wireless devices or performing a usability score of the first set of content files based on the characteristics of the first category of wireless devices.

The method can include performing a second web crawling process by traversing the path of links defined by the navigation history to retrieve a second set of content files, and analyzing the second set of content files for errors by emulating a second category of wireless devices. Using information about characteristics of the second category of wireless devices, the method can analyze content in the retrieved second set for errors that may occur in the use of the retrieved content at a wireless device in the second category. The content can be analyzed by identifying a second list of language elements that are supported by the second category of wireless devices, and performing a syntax check of the second set of content files using the second set of language elements. The second set of language elements may define a second markup language format. Alternatively, the content can be analyzed by performing a semantic check of the first set of content files based on characteristics of the second category of wireless devices or performing a usability score of the first set of content files based on characteristics of the second category of wireless devices.

The navigation history can identify an order in which the first set of content files are retrieved. The method can include receiving a seed URL that defines a starting point for the first web crawling process. The method can include providing a test configuration file including user data, and for each retrieved content file, determining whether the content file has input data fields, and if so, entering the user data in the input data fields and sending the user data to the web site.

The method can include providing the test configuration file by displaying a blank form on a screen of a computing device, the blank form having one or more input data fields, receiving input from a user entering user data into the one or more input data fields, and generating the test configuration file based on the user input. The user data can include one or more variable values that are used to create a dynamic URL. The link can include one or more variable values based on the first content file.

In another aspect, there is a computer program product, tangibly embodied in an information carrier, for validating wireless content. The computer program product is operable to cause data processing apparatus to perform a first web crawling process to retrieve a first set of content files from a web site, analyze the first set of content files for errors by emulating a first category of wireless devices, and generate a log file including a navigation history and error information, wherein the navigation history includes one or more paths of links traversed during the first web crawling process. The first web crawling process can include identifying a link in a first content file of the first set, and following the link to a second content file of the first set, the second content file including content based on the first content file.

In other examples, the computer program product has one or more of the following features. The computer program product can cause data processing apparatus to use information about characteristics of the first category of wireless devices to analyze content in the retrieved first set for errors that may occur in the use of the retrieved content at a wireless device in the first category.

The computer program product also causes data processing apparatus to perform a second web crawling process by traversing the path of links defined by the navigation history to retrieve a second set of content files, and analyze the second set of content files for errors by emulating a second category of wireless devices. The computer program product also causes data processing apparatus to use information about characteristics of the second category of wireless devices, analyze content in the retrieved second set for errors that may occur in the use of the retrieved content at a wireless device in the second category.

The computer program product also causes data processing apparatus to provide a test configuration file including user data, and for each retrieved content file, determine whether the content file has input data fields, and if so, enter the user data in the input data fields and send the user data to the web site. The computer program product also causes data processing apparatus to display a blank form on a screen of a computing device, the blank form having one or more input data fields, receive input from a user entering user data into the one or more input data fields, and generate the test configuration file based on the user input.

In another aspect, there is a system for validating wireless content. The system includes a communications system, a first computing device including content files, and a second computing device having a content validator program. The content validator program is configured to perform a first web crawling process to retrieve, through the communications system, a first set of content files from the first computing device, analyze the first set of content files for errors by emulating a first category of wireless devices, and generate a log file including a navigation history and error information, wherein the navigation history includes one or more paths of links traversed during the first web crawling process. The first web crawling process can include identifying a link in a first content file of the first set, and following the link to a second content file of the first set, the second content file including content based on the first content file.

In other examples, the system has one or more of the following features. The content validator program can be configured to perform a second web crawling process by traversing the path of links defined by the navigation history to retrieve a second set of content files, and analyze the second set of content files for errors by emulating a second category of wireless devices. The content validator program can also be configured to provide a test configuration file including user data, and for each retrieved content file, determine whether the content file has input data fields, and if so, enter the user data in the input data fields and send the user data to the first computing device. The content validator program can also be configured to display a blank form on a screen of a third computing device, the blank form having one or more input data fields, receive input from a user entering user data into the one or more input data fields, and generate a test configuration file based on the user input.

In another aspect, there is an apparatus for validating wireless content. The apparatus includes a means for performing a first web crawling process to retrieve a first set of content files, a means for analyzing the first set of content files for errors by emulating a first category of wireless devices, and a means for generating a log file including a navigation history and error information, wherein the navigation history includes one or more paths of links traversed during the first web crawling process. The first web crawling process includes identifying a link in a first content file of the first set, and following the link to a second content file of the first set, the second content file including content based on the first content file.

In other examples, the apparatus includes one or more of the following features. The apparatus can include a means for performing a second web crawling process by traversing the path of links defined by the navigation history to retrieve a second set of content files, and a means for analyzing the second set of content files for errors by emulating a second category of wireless devices. The apparatus can include a means for providing a test configuration file including user data, and for each retrieved content file, a means for determining whether the content file has input data fields, and if so, entering the user data in the input data fields and sending the user data to the first computing device. The apparatus can include a means for displaying a blank form on a screen of a computing device, the blank form having one or more input data fields, a means for receiving input from a user entering user data into the one or more input data fields, and a means for generating a test configuration file based on the user input.

Advantages that can be seen in particular implementations of the invention include one or more of the following. Web site content can be validated for multiple wireless devices, regardless of the network type, bearer, or device type. If an error is detected during the validation of content for one wireless device, an attempt can be made to reproduce the error on multiple other devices. Form input data can be prestored so that the testing of a web site having one or more forms can be done without user intervention. Other advantages of the particular implementation include performing an automatic crawl that would not require human intervention into the process; determining the depth of the link traversing to ensure the finiteness of the crawl process; determining and eliminating loops in the links to ensure finiteness of the process; performing automatic traversing for the purpose of regression testing of the once tested application. One implementation includes all of the foregoing advantages.

The details of one or more examples are set forth in the accompanying drawings and the description below. Further features, aspects, and advantages of the invention will become apparent from the description, the drawings, and the claims.

### DESCRIPTION OF DRAWINGS

FIG. 1a shows a flowchart of a content validation process.

FIG. 1b shows a flowchart of a web crawling process.

FIG. 2 shows a communications system.

### DETAILED DESCRIPTION

The example techniques described herein use a content validator program that enables a content provider to validate content at a web site to be delivered to different types of wireless devices. Content providers may author content using any one of a number of wireless or non-wireless language formats. As many types of wireless devices exist, each with its own display, memory, and processing capabilities, content developers may favor the use of a standard markup language, such as Wireless Markup Language (WML), in authoring content as a “write once, run anywhere” alternative to maintaining multiple versions of the same web site. However, this does not fully compensate for the large variation in the way content is displayed across multiple wireless devices as new markup languages emerge and device manufacturers impose certain limitations on usage of the markup languages and different devices require content tailoring to improve content usability. For example, some displays are long, while others are wide. Some browsers can display images, while others cannot. Some displays support color images, while other displays support grayscale or black and white images. Further, some wireless devices allow users to input commands using a numeric keypad, while others support stylus input or voice commands.

Once content is transmitted to a wireless device, the content provider does not know whether errors occur when the content is displayed on the wireless device during a user's interaction with the web site. For example, there may be errors such as a dead or broken link, the content may have an unterminated comment, an unknown declaration type, an undefined element, a character that is not allowed in an attribute specification list, to name a few. Furthermore, such errors may only show up intermittently since much of a user's interaction with a web site through the wireless device's microbrowser can be dynamic. For debugging situations, there is a need for the content provider to be able to test the web site for errors and generate reports which aid in the correction of the detected errors.

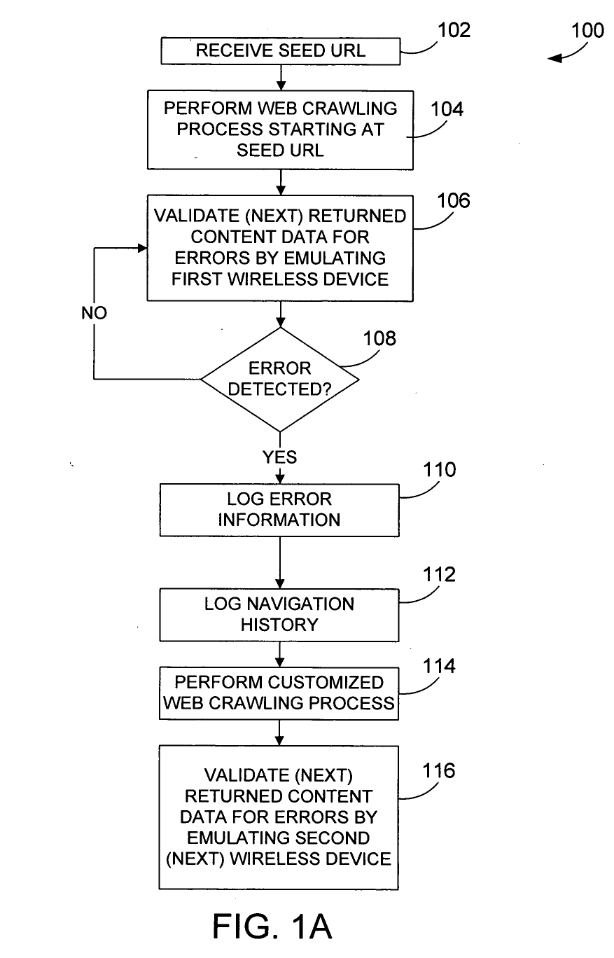

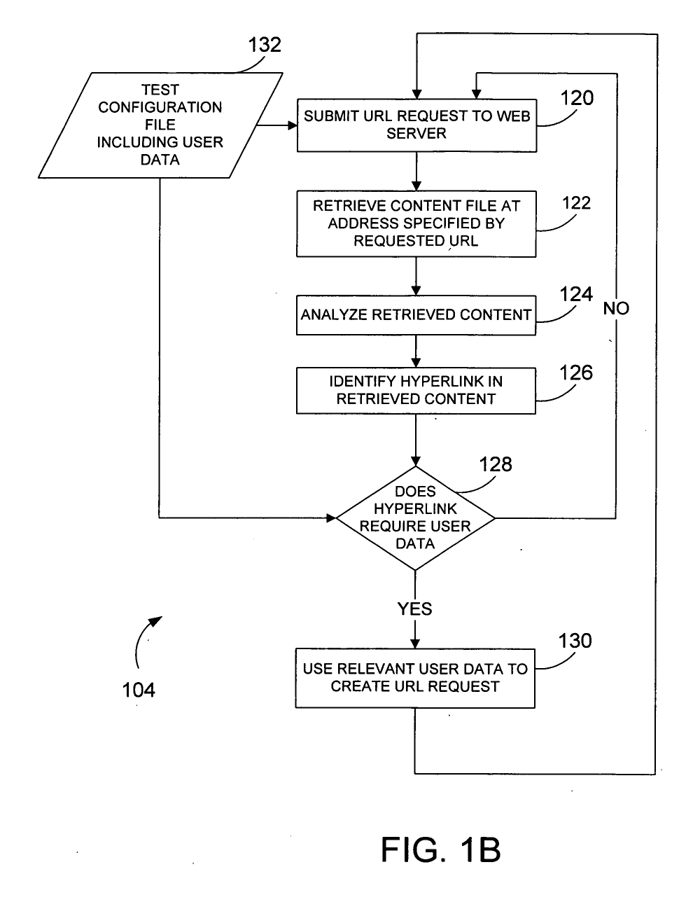

To aid the content provider in the debugging process, a content validator program simulates a user interaction with a web site for one or more wireless devices. FIG. 1a shows a content validation process 100, in which a content validator program receives (102) a seed URL, performs (104) a web crawling process starting at the seed URL, and validates (106) the returned content data for errors by emulating a first category of wireless devices. If an error is detected (108), the content validator program logs (110) information describing the error in a log file. The content validator program also maintains (112) a navigation history of the web crawling process in the log file. The navigation history includes a path of links traversed by the content validator during the web crawling process, and may optionally denote the links at which errors occur. The content validator program then uses the log file to perform (114) a customized web crawling process, and validates (116) the returned content data by emulating a second category of wireless devices. Process 100 can be repeated for any number of wireless devices and seed URLs.

The content validator program can form categories of devices based on one or some combination of the following device attributes: (1) the language in use on the device (e.g., English, Japanese, and French); (2) the language format supported by a microbrowser on the device (e.g., WML, xHTML, HTML for PDA, and HDML); (3) the type of microbrowser (e.g., Openwave Mobile Browser, Motorola Mobile Internet Browser, Access NetFront Browser); (4) the version of a microbrowser (e.g., Openwave Mobile Browser 7.x, Openwave Mobile Browser 6.x, and Openwave Mobile Browser 5.x); (5) the image supporting capability of the device (e.g., graphical user interface (GUI) browser and text-based browser); (6),the screen depth of the device display (e.g., 8-bit and 16-bit); (7) the color supporting capability of the device (e.g., grayscale and color); and (8) the maximum content length supported by a specific device (e.g. Openwave Mobile Browser 3.2 running on Sanyo phone cannot display the content if the content is larger than 1500 bytes). This list of device attributes is merely illustrative and the content validator program may use other device attributes. Each category can have one device or multiple devices.

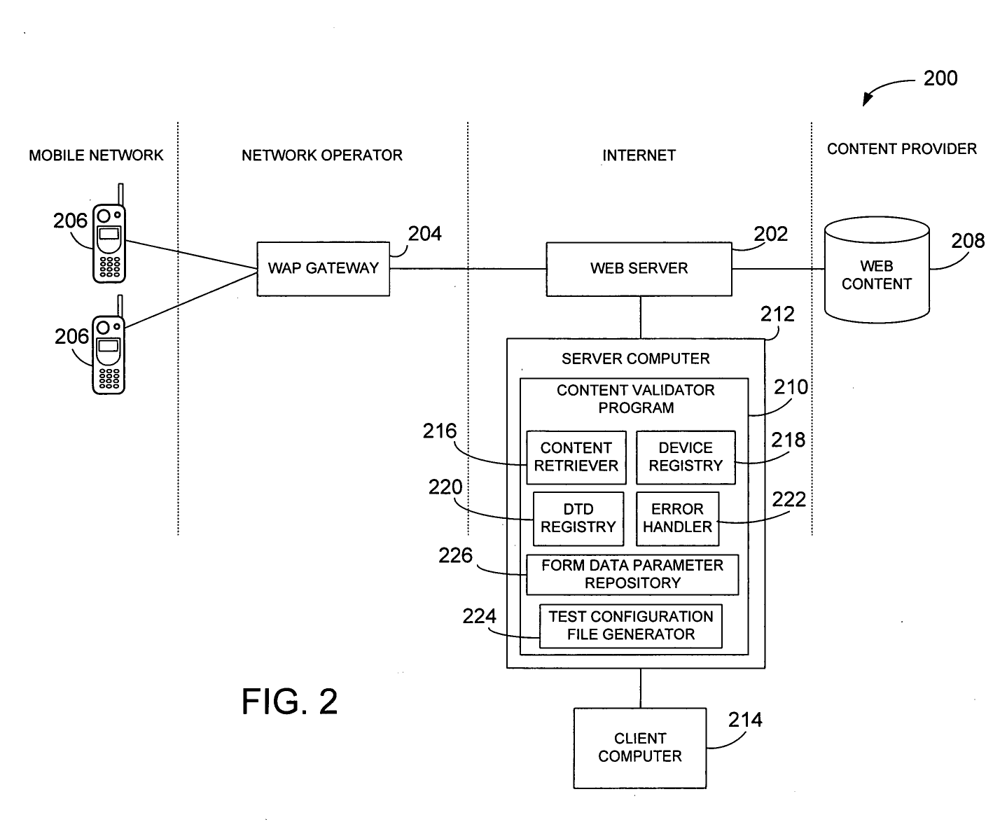

FIG. 2 shows a communications system 200 that supports communication between a Web server 202, a Wireless Application Protocol (WAP) gateway 204, and wireless devices 206 (e.g., a wireless WAP-enabled mobile phone). The Web server 202 includes or has access to web content 208, i.e., one or more files having content that is written in a markup language, such as WML, HDML, HTML for PDA or xHTML. Generally, each file corresponds to a unique Uniform Resource Locator (URL).

Each wireless device 206 has a microbrowser that supports a markup language format. More typically, each microbrowser supports a variant of a markup language format. The WAP forum provides a WML 1.3 Document Type Definition (DTD), which defines the language elements and attributes supported by the WML 1.3 specification. Microbrowser developers can create DTDs that support a superset or a subset of the WML 1.3 DTD so as to provide more functionality within the microbrowser application. For example, the WML 1.3 for Openwave DTD includes Openwave WML 1.3 extensions, which defines language elements and attributes that are not defined by the standard WML 1.3 DTD. These extended elements include the <link> element and the <spawn> element. All WAP-compliant microbrowsers and gateways are required to support extended DTDs. Generally, extended language elements are passed through unencoded by non-Openwave WAP gateways, and are ignored by non-Openwave microbrowsers. For the <link> element, this should have no serious effect on applications. However, an ignored <spawn> element could result in a disabled softkey, anchor, or select option on phones having microbrowsers that do not support the <spawn> element. Such errors can severely detract from a user experience while interacting with an application.

A mobile user can make a request for Web content by sending a URL request to the WAP gateway 204 using the microbrowser. The WAP gateway 204 transforms the URL request and forwards it to the appropriate Web server 202 using the HyperText Transfer Protocol (HTTP), for example. The Web server 202 interprets the URL request and a signature of the device 206 (e.g., device profile information, such as device identifier “LG 5350”) and responds to the WAP gateway 204 with the requested content file (e.g., a file having content formatted using the Wireless Markup Language (WML)).

The WAP gateway 204 can be configured to receive the requested file and analyze its content with respect to a DTD supported by the microbrowser of the requesting wireless device 206. For example, if the requesting wireless device 206 is a Verizon mobile phone having a WAP microbrowser that supports the WML 1.3 for Openwave DTD, the WAP gateway 204 (e.g., an Openwave Mobile Access Gateway) processes the WML-formatted content using the WML 1.3 for Openwave DTD. The WAP gateway 204 then encodes the content into bytecodes, and transmits the bytecodes to the requesting wireless device 206. The WAP microbrowser at the requesting wireless device 206 decodes the bytecodes and renders the content on a screen of the wireless device 206.

The system 200 includes a content validator program 210 that can be used by a content provider to validate its content by emulating one or more categories of wireless devices 206. In one example, the content validator program runs on the Web server 202. In the example illustrated in FIG. 2, the content validator program 210 runs on a server computer 212 that communicates with the Web server 202 over a network, which includes, for example, a portion of the Internet. The content provider interacts with the content validator program 210 through an interface similar to (or exactly the same as) that which is used by a specific mobile device 206. A user interface is presented to a human operating a content validator if any human intervention is required. For example, in a web-based implementation, the user interacts with the content validator program 210 running on the server computer 212 through a browser window displayed on a client computer 214. Through the content validator program's user interface, the user can enter one or more seed URLs that serve as starting points for one or more web crawling processes. The user can also identify one or more categories of wireless devices 206 for which the content is validated.

The content validator program 210 includes a form data parameter repository 226, content retriever 216, a device registry 218, a DTD registry 220, and an error handler 222. The content retriever 216 begins a web crawling process by retrieving a content file at the address specified by a seed URL, where each content file represents a page of a web site. For example, the content retriever 216 uses HTTP or File Transfer Protocol (FTP) to retrieve a WML-formatted content file from the Web server 202. The content retriever 216 searches the contents of the retrieved file for information within tags that contain hyperlinks to other web files. A hyperlink includes a specification of a web address, such as a URL.

The content retriever 216 identifies a hyperlink in the retrieved file, and follows the hyperlink to a second page of the web site. In one example, the first retrieved file represents a quotes page having a list of stocks (e.g., Lucent Technologies Inc. (LU), Nortel Networks Corp (NT), and AT&T Wireless (AWE)). Each stock on the quotes page has a hyperlink to a second page that provides detailed information about the stock. Selection of the hyperlink for the Nortel Networks Corp. stock, for example, would result in the retrieval of a second content file that includes Nortel-specific content, such as company information, stock quotes (e.g., Day's High, Day's Low, 52 Wk High, 52 Wk Low), and news stories. The second content file may itself contain hyperlinks to other web files, including a third content file. If the third content file contains dynamically created content, then the link from the second content file, that contains Nortel-specific content, may include a parameter so that the dynamically created content of the third content file is also Nortel-specific content.

As the content retriever 216 perform's the web crawling process (i.e., identify a link on a first page and follow the link to a second page, identify a link on the second page and follow the link to a third page, and so on), the content validator program 210 stores the WML state in a log file, e.g., a WML browser context. The WML browser context is used to manage all parameters and user agent states, including variables (e.g., variable values that are entered into a “news story” database to create a dynamic URL), the navigation history and other implementation-dependent information related to the current state of the content validator program 210 as it emulates a category of wireless devices. In one implementation, the content validator program stores one or more paths of links traversed during the web crawling process as navigation history. Each path typically starts with the seed URL and identifies an order of links that are subsequently selected by the content validator program to retrieve content files. The content validator program 210 can be configured to limit the number of files that are retrieved during the web crawling process to a predetermined or user-defined number. Once a content file is retrieved, the content data within the file can be validated by the content validator program 210 emulating a wireless device 206 or a category of wireless devices 206. Suppose, for example, that the user identified two wireless devices 206 (e.g., LG 5350 and Sanyo 5300) for which the content is to be validated. The process of validating the content for each of the two user-identified wireless devices 206 basically validates the content for the categories of wireless devices that share device attributes (e.g., browser version) as the user-identified wireless devices 206. The content validator program 210 first retrieves device profile information related to one of the user-identified wireless devices 206 (e.g., LG 5350) from the device registry 218. In one implementation, device profile information relating to all wireless devices 206 on the system 200 is stored in the device registry 218. Such device profile information includes a device identifier (e.g., LG 5350), and device attributes (e.g., device has a GUI browser or a text-based browser, device has Openwave Mobile Browser 6.1 microbrowser or Access NetFront v3.1 microbrowser). Generally, the browser version information identifies the DTD supported by the device's microbrowser (e.g., WML 1.3 for Openwave DTD). Updates to the device registry 218 can be obtained from an independent central source, such as a provider (e.g., Openwave Systems Inc.) of a WAP gateway 204 (e.g., Openwave Mobile Access Gateway) on the system 200.

If, on the other hand, the user identified two categories of wireless devices 206 (e.g., the first category of devices having a GUI Openwave Mobile Browser 6.1 microbrowser, and the second category of devices having a text-based Openwave Mobile Browser 6.1 microbrowser) for which the content is to be validated, the content validator program can bypass the device profile information retrieval process and identify the DTD supported by the microbrowser.

The content validator program 210 retrieves information associated with the identified DTD (e.g., WML 1.3 for Openwave DTD) from the DTD registry 220. In one implementation, a language template for each DTD is stored in the DTD registry 220 (e.g., WML 1.3 for Openwave DTD language template). Each language template provides a list of language elements that are valid for a particular DTD. For example, the WML 1.3 DTD language template provides a list of 36 language elements that are valid for a microbrowser that is in compliance with the WML 1.3 specification. In another example, the WML 1.3 for Openwave DTD language template provides a list of 44 language elements that are valid for a microbrowser that can handle the 36 language elements in the WML 1.3 DTD, as well as the 8 language elements that are Openwave extensions to WML 1.3. The content validator program 210 then validates the content data using the language template retrieved from the DTD registry 220. For example, the content validator program 210 performs a syntax check of the content data (i.e., the WML 1.3-formatted content data) using the-WML 1.3 for Openwave DTD language template to determine whether errors occur when a user views the content file with the Openwave Mobile Browser 6.1. Examples of syntax errors that can be identified by the content validator program 210 include misspelled or invalid tag names, tag attributes, tag attribute values, and character entities (e.g., ‘&#38’ represents the character ‘&’), missing and mismatched quotation marks, missing or extra closing tags, unacceptable size of the content retrieved, incorrect placing and nesting of tags, and broken links.

The content validator program 210 can also be configured to identify incorrect or incompatible browser or browser version-specific tags (e.g., a WML 1.3 for Openwave extension), attributes, and attribute values that cannot be processed by the language format (e.g., WML 1.3 DTD) supported by the user-identified wireless device 206. For example, the WML 1.3 for Openwave <do> element has been extended to support the specification of images as <do> element labels. This is specified with an <img> element embedded inside a <do> element as follows:

```
<do type=“accept”>
    <go href=“/foo”/>
    <img src=“img” localsrc=“OK” alt=“OK”/>
</do>
```

The content validator program 210 first determines whether the user-identified wireless device 206 or category of wireless devices 206 has a GUI browser or a text-based browser by looking up the device characteristics information stored in the device registry 218. If the wireless device 206 or category of wireless devices 206 has a GUI browser, the content validator program 210 makes a determination as to whether the version of the microbrowser on the wireless device 206 supports images by checking the language template associated with the wireless device 206. If the <img> element is a part of the DTD language template, the <do> element is processed for errors as described above. If the <img> element is not a part of the DTD language template, the content validator program 210 does not process the <do> element for errors and identifies this particular <do> element as being incompatible with the microbrowser. If errors are detected during the testing process, the error handler 222 of the content validator program 210 logs an application message for each error. The application messages may have levels to specify debug, informational, warning and error conditions. In one implementation, each application message is appended to a URL in the log file in a manner that allows a content provider reviewing the log file (e.g., on a screen at the client computer 214 as shown in FIG. 3) to identify the content file in which the error occurred.

Examples of the error log messages can be (but are not limited to) the following:
http://ammk41.fmr.com:20441/nf/OrderStatusMain;jsessionid=0000FPY ZRAX1BCNRI2MIIWPZMCY:v2jvibgb | (0,0) (0) | The following tags were not closed: wml. |
http://ammk41.fmr.com:20441/nf/GetRealtimeCategoryHeadlinesDetail;jsessionid=00001I33ANKEWBMTSMYFOORXIOY:v2jvibgb?query=@TN/TEPN|@IN/EMI|@IN/ECO&action=detail&STORYID=-NEWS.CBSMW.00000000.810608575&PROVIDER=Reuters&PRODUCT=RTR/COMPRT | (23,42) (622) | An invalid character was found in text content. |01:42 a.m.&amp;nbsp;12/17/2003
http://ammk41.fmr.com:20441/nf/ModifywatchList;jsessionid=0000NJCUGPEWIEPG2YQM5HTD1IA:v2jvibgb?modify_option=R&sym=$sym&index=$index&qty=$qty&price=$price&watch_list_num=0 |Got AppError:
http://ammk41.fmr.com:20441/nf/ModifyWatchList;jsessionid=0000NJCUGPEWIEPG2YQM5HTDlIA:v2jvibgb?modify_option=R&sym=$sym&index=$index&qty=$qty&price=$price&watch_list_num=0
http://ammk41.fmr.com:20441#c4 |Error 404 getting
http://ammk41.fmr.com:20441#c4
http://ammk41.fmr.com:20441/nf/home | (23,8) (564) | Element content is invalid according to the DTD/Schema. Expecting: do, p, pre. | </p><b><p>.

The content validator program 210 then attempts to reproduce the errors using a different wireless device 206, e.g., the second user-identified wireless device (i.e., Sanyo 5300 having an Access NetFront v3.1 microbrowser that supports WML 1.3 for Access DTD) or the second category of wireless devices (i.e., devices having a text-based Openwave Mobile Browser 6.1 microbrowser). To do so, the content validator program 210 generates and performs a customized web crawling process using the information stored in the browser context during the initial web crawling process presenting itself to the web server 202 as a wireless device 206. That is, the content validator program 210 uses the same parameters and input variables to retrieve content files in the same order specified by the one or more paths of links stored as a navigation history of the initial web crawling process. The content validator program 210 also retrieves information related to a second user-identified wireless device 206 or category of wireless devices 206 from the device registry 218 and the DTD registry 220, as necessary. The content validator uses the retrieved language template to validate the content data. For example, the content validator program 210 performs a syntax check of the content data (i.e., the WML 1.3-formatted content data) using a WML 1.3 for Access DTD language template to determine whether errors occur when a user views the content file with the Access NetFront v3.1 microbrowser in the manner described above. In so doing, the content validator program 210 can validate the content at a web site for delivery to any number or category of wireless devices 206.

Optionally, the content validator program 210 includes a test configuration file generator 222. Some web sites require the user to provide pieces of information while interacting with the web site. Such information for a “stock purchase” process, for example, can include the user's name, password, a name of a stock that the user wishes to purchase, and the quantity of the identified stock the user wishes to purchase, to name a few. To test the “stock purchase” process, a quality assurance (QA) engineer associated with the client provider simulates a hypothetical user interaction with the web site. For example, the QA engineer may start the “stock purchase” process by entering the URL of the content provider's web site home page. As the QA engineer clicks through the web site, the content validator program 210 retrieves content files from the Web server 202, displays web pages on a screen at the client computer 214, and stores the WML state in a browser context. The browser context is used to manage all parameters and user agent states, including variables, the navigation history (e.g., a list of all URLs that have been hit during the current “stock purchase” process) and other implementation-dependent information related to the current state of the content validator program 210 as the QA engineer simulates a user interaction with a web site.

In some instances, the displayed web pages have input data fields that users can fill in with data. On such web pages, the QA engineer manually enters data into all of the input fields of the displayed page and clicks on a “Submit” button displayed on the screen. The client computer 214 transmits the user data to the content validator program 210, which stores the user data as values in the specified variables. The test configuration file generator 222 creates a “stock purchase” test configuration file that includes the navigation history, as well as all of the user data that is submitted by the client computer 214 during the QA engineer's simulation of a user interaction with the web site such as a specific ticker and stock quantity for the “stock purchase” test. In one implementation, the test configuration files generated by the test configuration file generator 222 are stored in the form data parameter repository 226.

The implementation is not limited to the architecture where the client computer 214 and a server computer 212 are two separate computers. In one example, both the client computer 214 and the server computer 212 are implemented in the same physical computer.

Referring to FIG. 1b, the content validator program 210 uses the “stock purchase” test configuration file 132 as an input to the web crawling process 104. The content retriever 216 begins a web crawling process by submitting (120) a URL request (e.g., the seed URL) to the Web server 202 and retrieving (122) a content file at the address specified by the requested URL. After the content file (e.g., Web page) is validated (106, FIG. 1a) for a first category of devices, the: content retriever 216 analyzes (124) the retrieved content and identifies (126) a hyperlink in the retrieved file as the next link in the path based on the navigation history stored in the test configuration file. The content validator program 210 determines (128) whether the link requires user data, and if so, uses the relevant user data in the “stock purchase” test configuration file 132 (e.g., entering a ticker symbol in an input data field) to create (130) a URL request. The content validator program 210 then submits (120) the URL request (including the user data, if necessary) to the Web server 202 and the process 104 is repeated. In so doing, the content validator program 210 can perform a web crawling process and simulate a user's interaction with the web site without any user intervention. As described above, the web crawling process 104, namely the URLs submitted (e.g., 120) and any parametric data passed with those URLs (e.g., 130), can be stored as navigation history while the web crawling process 104 is taking place. This navigation history can then be repeated for different categories of devices, so that each page can be validated (106) for a different category of devices following the same navigation path. This advantageously provides to a quality assurance engineer an automated process to determine whether the same navigation path (e.g., the path saved in the navigation history) will produce errors for different categories of devices.

The content validator program 210 also retrieves information related to one of the user-identified wireless devices 206 (e.g., LG 5350 having an Openwave Mobile Browser 6.1 that supports WML 1.3 for Openwave DTD) from the device registry 218 and the DTD registry 220. Each file of content data that is retrieved can be validated by the content validator program 210 for errors in the manner described above. If errors are detected while the content validator program 210 emulating the first wireless device 206 performs the “stock purchase” process, the error handler 222 of the content validator program 210 logs an application message for each error as described above.

The content validator program 210 then attempts to reproduce the errors by presenting itself as a different wireless device 206, e.g., the second user-identified wireless device (i.e., Sanyo 5300 having an Access NetFront v3.1 microbrowser that supports WML 1.3 for Access DTD). To do so, the content validator program 210 generates and performs a customized “stock purchase” process using the information stored in the browser context during the initial “stock purchase” process and the signature of the device 206 retrieved from the device registry 218. That is, the content validator program 210 uses the same parameters and input variables to retrieve content files in the same order as the initial “stock purchase” process. The content validator program 210 also retrieves information related to a second user-identified wireless device 206 from the device registry 218 and the DTD registry 220, and validates the retrieved content data for errors as described above. In this manner, the “stock purchase” test configuration file can be used with any number of wireless devices 206 signatures stored in the device registry 218 to validate content at a web site.

As different devices 206 have different physical characteristics, such as screen size, the content validator program 210 may perform usability scoring of the content, by keeping track of the number of button clicks needed in order for a user to scroll to the end of a particular page displayed on the device 206.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims. The following are examples for illustration only and not to limit the alternatives in any way. The techniques described herein can be performed in a different order and still achieve desirable results.

1. A method for validating wireless content comprising:
performing a first web crawling process to retrieve a first set of content files from a web site, the first web crawling process including
identifying a link in a first content file of the first set, and
following the link to a second content file of the first set, the second content file including content based on the first content file;
analyzing the first set of content files for errors by emulating a first category of wireless devices; and
generating a log file including a navigation history and error information, wherein the navigation history includes one or more paths of links traversed during the first web crawling process.

2. The method of claim 1, wherein analyzing the first set of content files for errors comprises:
based on information about characteristics of the first category of wireless devices, analyzing content in the retrieved first set for errors that may occur in the use of the retrieved content at a wireless device in the first category, the retrieved content being configured for use on a wireless device in the first category.

3. The method of claim 2, wherein analyzing content comprises:
identifying a first list of language elements that are supported by the first category of wireless devices; and
performing a syntax check of the first set of content files using the first set of language elements.

4. The method of claim 3, wherein the first set of language elements define a markup language format.

5. The method of claim 2, wherein analyzing content comprises:
performing a semantic check of the first set of content files based on the characteristics of the first category of wireless devices.

6. The method of claim 2, wherein analyzing content comprises:
performing a usability score of the first set of content files based on the characteristics of the first category of wireless devices.

7. The method of claim 1, further comprising:
performing a second web crawling process by traversing the path of links defined by the navigation history to retrieve a second set of content files; and
analyzing the second set of content files for errors by emulating a second category of wireless devices.

8. The method of claim 7, wherein analyzing the second set of content files for errors comprises:
based on information about characteristics of the second category of wireless devices, analyzing content in the retrieved second set for errors that may occur in the use of the retrieved content at a wireless device in the second category, the retrieved content being configured for use on a wireless device in the second category.

9. The method of claim 8, wherein analyzing content comprises:
identifying a second list of language elements that are supported by the second category of wireless devices; and
performing a syntax check of the second set of content files using the second set of language elements.

10. The method of claim 9, wherein the second set of language elements define a second markup language format.

11. The method of claim 8, wherein analyzing content comprises:
performing a semantic check of the first set of content files based on characteristics of the second category of wireless devices.

12. The method of claim 8, wherein analyzing content comprises:
performing a usability score of the first set of content files based on characteristics of the second category of wireless devices.

13. The method of claim 1, wherein the navigation history identifies an order in which the first set of content files are retrieved.

14. The method of claim 1, further comprising:
receiving a seed URL that defines a starting point for the first web crawling process.

15. The method of claim 1, further comprising:
providing a test configuration file including user data; and
for each retrieved content file, determining whether the content file has input data fields, and if so, entering the user data in the input data fields and sending the user data to the web site.

16. The method of claim 15, wherein providing the test configuration file comprises:
displaying a blank form on a screen of a computing device, the blank form having one or more input data fields;
receiving input from a user entering user data into the one or more input data fields; and
generating the test configuration file based on the user input.

17. The method of claim 16, wherein the user data includes one or more variable values that are used to create a dynamic URL.

18. The method of claim 1, wherein the link includes one or more variable values based on the first content file.

19. A computer program product, tangibly embodied in an information carrier, for validating wireless content, the computer program product being operable to cause data processing apparatus to:
perform a first web crawling process to retrieve a first set of content files from a web site, the first web crawling process including
identifying a link in a first content file of the first set, and
following the link to a second content file of the first set, the second content file including content based on the first content file;
analyze the first set of content files for errors by emulating a first category of wireless devices; and
generate a log file including a navigation history and error information, wherein the navigation history includes one or more paths of links traversed during the first web crawling process.

20. The product of claim 19, wherein instructions to analyze the first set of content files for errors comprise instructions to:
based on information about characteristics of the first category of wireless devices, analyze content in the retrieved first set for errors that may occur in the use of the retrieved content at a wireless device in the first category, the retrieved content being configured for use on a wireless device in the first category.

21. The product of claim 19, further comprising instructions to:
perform a second web crawling process by traversing the path of links defined by the navigation history to retrieve a second set of content files; and
analyze the second set of content files for errors by emulating a second category of wireless devices.

22. The product of claim 21, wherein instructions to analyze the second set of content files for errors comprise instructions to:
based on information about characteristics of the second category of wireless devices, analyze content in the retrieved second set for errors that may occur in the use of the retrieved content at a wireless device in the second category, the retrieved content being configured for use on a wireless device in the second category.

23. The product of claim 19, further comprising instructions to:
provide a test configuration file including user data; and
for each retrieved content file, determine whether the content file has input data fields, and if so, enter the user data in the input data fields and send the user data to the web site.

24. The product of claim 23, wherein instructions to provide the test configuration file comprise instructions to:
display a blank form on a screen of a computing device, the blank form having one or more input data fields;
receive input from a user entering user data into the one or more input data fields; and
generate the test configuration file based on the user input.

25. A system for validating wireless content, the system comprising:
a communications system;
a first computing device including content files; and
a second computing device having a content validator program, the content validator program configured to:
perform a first web crawling process to retrieve, through the communications system, a first set of content files from the first computing device, the first web crawling process including identifying a link in a first content file of the first set, and following the link to a second content file of the first set, the second content file including content based on the first content file;
analyze the first set of content files for errors by emulating a first category of wireless devices; and
generate a log file including a navigation history and error information, wherein the navigation history includes one or more paths of links traversed during the first web crawling process.

26. The system of claim 25, wherein the content validator program is further configured to:
perform a second web crawling process by traversing the path of links defined by the navigation history to retrieve a second set of content files; and
analyze the second set of content files for errors by emulating a second category of wireless devices.

27. The system of claim 25, wherein the content validator program is further configured to:
provide a test configuration file including user data; and
for each retrieved content file, determine whether the content file has input data fields, and if so, enter the user data in the input data fields and send the user data to the first computing device.

28. The system of claim 25, wherein the content validator program is further configured to:
display a blank form on a screen of a third computing device, the blank form having one or more input data fields;
receive input from a user entering user data into the one or more input data fields; and
generate a test configuration file based on the user input.

29. An apparatus comprising:
a means for performing a first web crawling process to retrieve a first set of content files, the first web crawling process including
identifying a link in a first content file of the first set, and
following the link to a second content file of the first set, the second content file including content based on the first content file;
a means for analyzing the first set of content files for errors by emulating a first category of wireless devices; and
a means for generating a log file including a navigation history and error information, wherein the navigation history includes one or more paths of links traversed during the first web crawling process.

30. The apparatus of claim 29, further comprising:
a means for performing a second web crawling process by traversing the path of links defined by the navigation history to retrieve a second set of content files; and
a means for analyzing the second set of content files for errors by emulating a second category of wireless devices.

31. The apparatus of claim 29, further comprising:
a means for providing a test configuration file including user data; and
for each retrieved content file, a means for determining whether the content file has input data fields, and if so, entering the user data in the input data fields and sending the user data to the first computing device.

32. The apparatus of claim 29, further comprising:
a means for displaying a blank form on a screen of a computing device, the blank form having one or more input data fields;
a means for receiving input from a user entering user data into the one or more input data fields; and
a means for generating a test configuration file based on the user input.
